(19) United States
(12) Patent Application Publication
(10) Pub. No.: US 2011/0070790 A1
(43) Pub. Date: Mar. 24, 2011

(54) Structure of Spacer Fabric Surface Layer and Reinforced Knitting Method of Producing the same

(76) Inventors: Chang-Ching Liu, Dou-Liu City (TW); Li-Chung Ting, Dou-Liu City (TW)

(21) Appl. No.: 12/563,678

(22) Filed: Sep. 21, 2009

(51) Int. Cl. B32B 5/26; D04B 1/22; D03D 9/00

(52) U.S. Cl. 442/32; 66/196; 442/2

(57) ABSTRACT

In a structure of spacer fabric surface layer and a reinforced knitting method of producing the structure, the method includes a surface mesh layer, a middle support layer and a bottom fabric layer; wherein the surface mesh layer is consisted of a plurality of main segments and extending segments, each main segment is formed by lapping two loop strings, and each extending segment includes one single loop string, the loop string is formed by stringing a plurality of loops; when in the knitting process, moving the yarn of the middle support layer up and down between the surface mesh layer and the bottom fabric layer to let the yarn of the middle support layer connect with the main segment of the surface mesh layer at one end and connect with the bottom fabric layer at the other end, therefore, the yarn of the middle support layer laps with the extending segment when it moves to the extending segment to reinforce the extending segment.

### BACKGROUND OF THE INVENTION

1. Field of the Invention

The present invention relates to a structure of spacer fabric surface layer and a reinforced knitting method of producing the structure, which comprises a middle support layer having a yarn lapped with an extending segment of a surface mesh layer to reinforce the surface mesh layer.

2. Description of the Prior Art

Please refer to FIG. 1A and FIG. 1B for a conventional spacer fabric which comprises a bottom layer 11, a middle layer 12 and a surface layer 13, wherein the surface layer 13 forms in meshes or polyhedral meshes; each mesh or polyhedral mesh comprises a main segment 131 and an extending segment 132; the main segment 131 is formed by lapping two loop strings to knit the surface layer 13 into meshes, while the extending segment 132 only comprises one single loop string, and the loop string is formed by stringing a plurality of loops; when the middle layer 12 moves up and down between the bottom layer 11 and the surface layer 13, one end of the middle layer 12 connects with the main segment 131 and the extending segment 132 of the surface layer 13, while the other end connects with bottom layer 11 to form the spacer fabric with a sandwiched structure. However, the extending segment 132 of the surface layer 13 only comprises one single loop string and cannot provide enough strength to the structure; besides, the extending segment 132 is supported by the middle layer 12, so when the surface layer 13 is rubbed, the main segment 131 and the extending segment 132 are being rubbed at the same time since they are connected with each other. In the long term, extending segment 132 could break off first due to its weak strength, leading to the destruction and disabling of the mesh of the surface layer 13.

Therefore, the conventional structure and knitting method still present some shortcomings to be overcome.

In view of the deficiencies of the prior art techniques, after years of constant researches, the inventor has successfully proposed a structure of spacer fabric surface layer and a reinforced knitting method of producing the structure in the present invention.

### SUMMARY OF THE INVENTION

It is an object of the present invention to provide a structure of spacer fabric surface layer and a reinforced knitting method of producing the structure; as in the process of knitting the middle support layer, the yarn of the middle support layer is lapped with the extending segment of the surface mesh layer to reinforce the strength of the extending segment with the middle support layer.

It is another object of the present invention to provide a structure of spacer fabric surface layer and a reinforced knitting method of producing the structure, which is easy to produce and sustainable to prolong the lifetime of the product.

In order to achieve the above objects, the present invention discloses a structure of spacer fabric surface layer and a reinforced knitting method of producing the structure; the steps of the knitting method comprising; disposing a yarn into a knitting machine; knitting the yarn to form a three laminated fabric layer structure having a surface mesh layer, a middle support layer and a bottom fabric layer from top to bottom by using the knitting machine, wherein the surface mesh layer is knitted into meshes or polyhedral meshes, the surface mesh layer is consisted of a main segment having two loop strings lapping with each other and an extending segment having one single loop string, each loop string is formed by stringing a plurality of loops; when in the process of knitting the middle support layer, moving the yarn up and down to have the yarn knitted between the main segment of the surface mesh layer and the bottom fabric layer to let the one end of the yarn of the middle support layer connect with the main segment of the surface mesh layer and the other end connect with the bottom fabric layer, when the yarn of the middle support layer moves to the extending segment of the surface mesh layer, it laps with the extending segment to reinforce the strength of the extending segment and leaves the extending segment with no support of the middle support layer from down under; then in the steps of the knitting method, moving the yarn of the middle support layer up and down between the main segment and the bottom fabric layer until the surface mesh layer is fully supported, wherein the yarn of the middle support layer laps with all the extending segments laps to reinforce the extending segments.

These features and advantages of the present invention will be fully understood and appreciated from the following detailed description of the accompanying drawings.

### BRIEF DESCRIPTION OF THE DRAWINGS

FIG. 1A and FIG. 1B illustrate a conventional spacer fabric;

FIG. 2 illustrates a flowchart of the reinforced knitting method of producing the structure of the spacer fabric surface layer in the present invention;

FIG. 3 illustrates a structural view of the structure of the spacer fabric surface layer in the present invention;

FIG. 4 illustrates a structural view of another embodiment of the structure of the spacer fabric surface layer in the present invention; and

FIG. 5 illustrates a structural view of still another embodiment of the structure of the spacer fabric surface layer in the present invention; and

FIG. 6 illustrates a structural view of still another embodiment of the structure of the spacer fabric surface layer in the present invention.

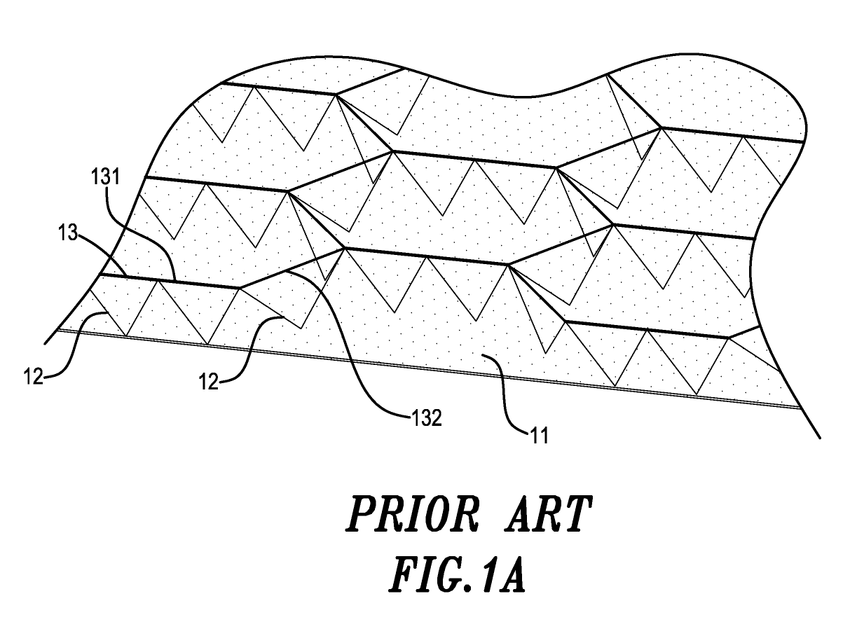

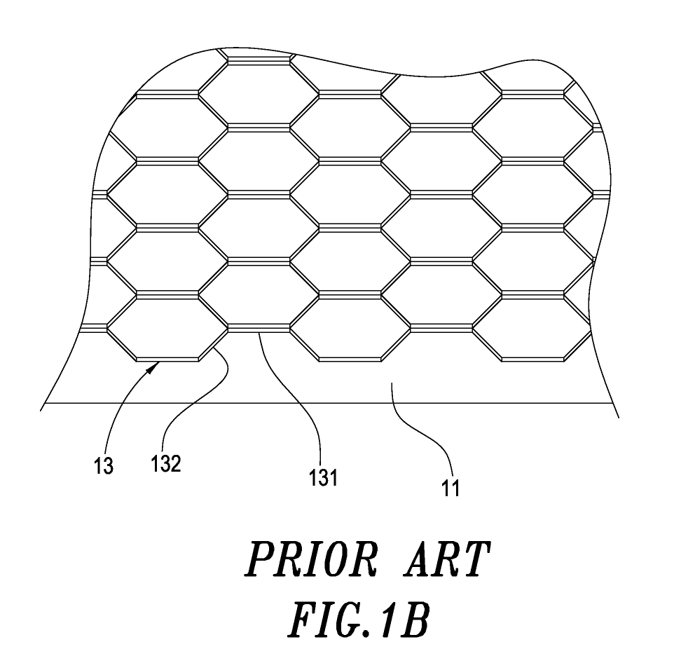

### DETAILED DESCRIPTION OF THE PREFERRED EMBODIMENT

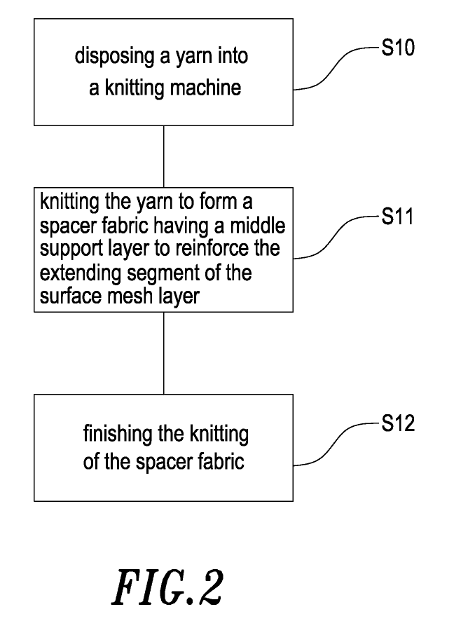

Please refer to FIG. 2 for a flowchart of a reinforced knitting method of producing a structure of a spacer fabric surface layer in the present invention, the method comprises the following steps:

S10: disposing a yarn into a knitting machine;

S11: knitting the yarn to form a spacer fabric having a surface mesh layer, a middle support layer and a bottom fabric layer by using the knitting machine, wherein the surface mesh layer is knitted into meshes, so the surface mesh layer is consisted of a main segment having two loop strings lapping with each other and an extending segment having one single loop string; as in the process of knitting the middle support layer, moving the yarn up and down to have the yarn knitted between the main segment of the surface mesh layer and the bottom fabric layer to let one end of the yarn of the middle support layer connect with the main segment and the other end connect with the bottom fabric layer, when the yarn of the middle support layer moves to the extending segment of the surface mesh layer, it laps with the extending segment to reinforce the strength of the extending segment; then moving the yarn of the middle support layer up and down between the main segment and the bottom fabric layer to knit the yarn between the main segment and the bottom fabric layer;

S12: finishing the knitting of the three laminated layer fabric.

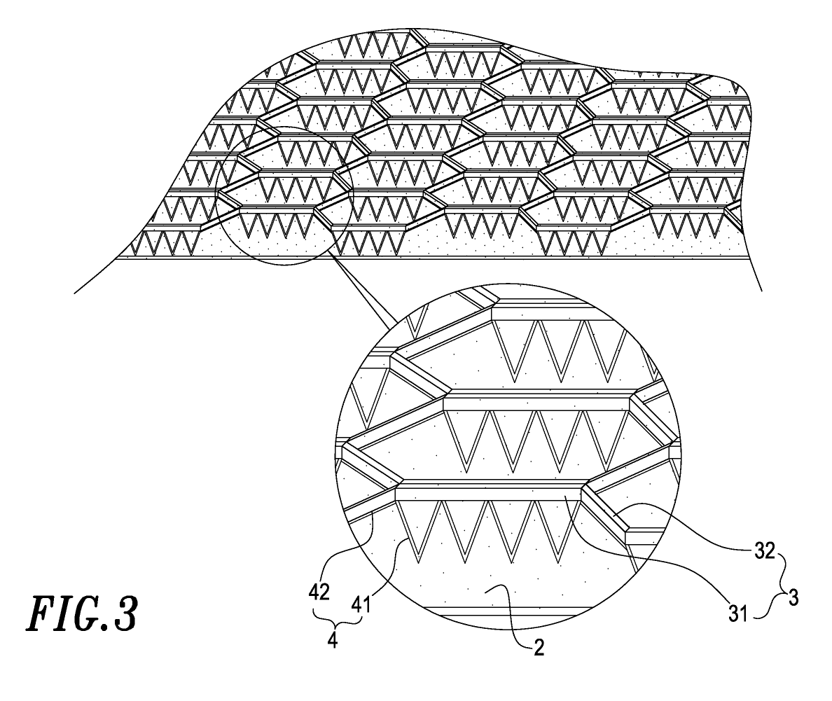

Please refer to FIG. 3 for a structural view of the structure of the spacer fabric surface layer in the present invention, the structure comprises:

a bottom fabric layer 2;

a surface mesh layer 3 consisted of meshes, hexagonal meshes or polyhedral meshes in honeycomb shape. The surface mesh layer 3 comprises a plurality of main segments 31 having ends connected and a plurality of extending segments 32, the main segments 31 and the extending segments 32 are formed in one body, so each main segment 31 comprises at least two lapping loop strings, and each extending segment 32 only comprises one single loop string, the loop string is formed by stringing a plurality of loops; when the surface mesh layer 3 is formed in polyhedral meshes or quadrangles in honeycomb shape, two neighboring loop strings are lapped first to form a main segment 31, then an end portion of the main segment 31 start to separate to form extending segments 32, when the extending segments 32 join again to lap with each other, the two loop strings would lap with each other to form the main segment 31 again; therefore a polyhedral mesh or a quadrangle in honeycomb shape is formed by repeating the above knitting process; wherein the main segment 31 comprises two loop strings, and the extending segment 32 comprises only one single loop string;

a middle support layer 4 comprising a vertical yarn 41 and a horizontal yarn 42, the vertical yarn 41 has one end connected with the main segment 31 of the surface mesh layer 3 and the other end connected with the bottom fabric layer 2 to act as a support to the surface mesh layer 3, and the horizontal yarn 42 of the middle support layer 4 lapping with the extending segment 32 of the surface mesh layer 3 to reinforce the strength of the extending segment 32.

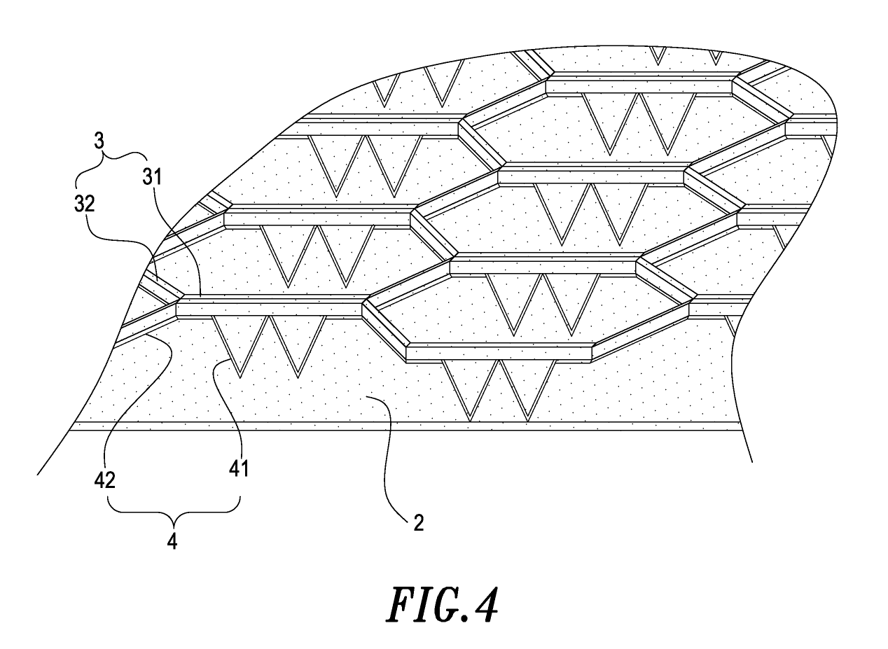

Please refer to FIG. 4 for a structural view of another embodiment in the present invention. The difference between FIG. 4 and FIG. 3 is that the vertical yarn 41 of the middle support layer 4 only supports the front portion or the portion near the rear portion of the main segment 31 of the surface mesh layer 3; and the front portion and the rear portion of the main segment 31, and the front portion and the rear portion of the main segment 31, and the extending segment the extending segment 32 lap with the horizontal yarn 42 of the middle support layer 4 to further reinforce the strength of the extending segment 32. The rest of the structure in FIG. 4 is the same as that in FIG. 3 and will not be described for the sake of brevity.

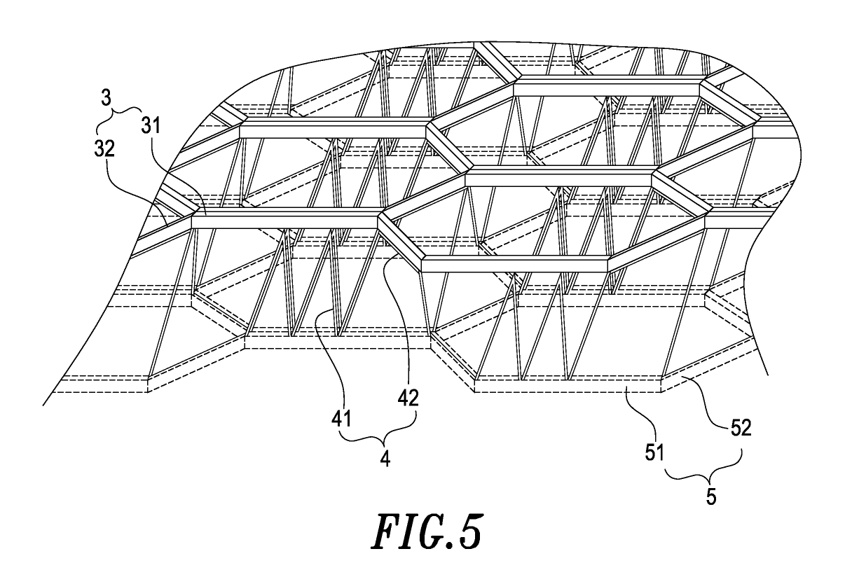

Please to FIG. 5 for a structural view of still another embodiment in the present invention. In FIG. 5, the bottom fabric layer 2 can be a bottom mesh layer 5, the bottom mesh layer 5 comprises a plurality of main segments 51 having ends connected and a plurality of extending segments 52, each main segment 51 comprises at least two lapping loop strings, and each extending segment 52 only comprises one single loop string, therefore the bottom mesh layer 5 is formed in meshes; the vertical yarn 41 of the middle support layer 4 has one end connected with the main segment 31 of the surface mesh layer 3 and the other end connected with the main segment 51 of the bottom mesh layer 5 to support the surface mesh layer 3; the horizontal yarn 42 of the middle support layer 4 laps with the extending segments 32, 52 of the surface mesh layer 3 and the bottom mesh layer 4 respectively to reinforce the strength of the extending segment. The rest of the structure in FIG. 5 is the same as that in FIG. 3 and will not be described for the sake of brevity.

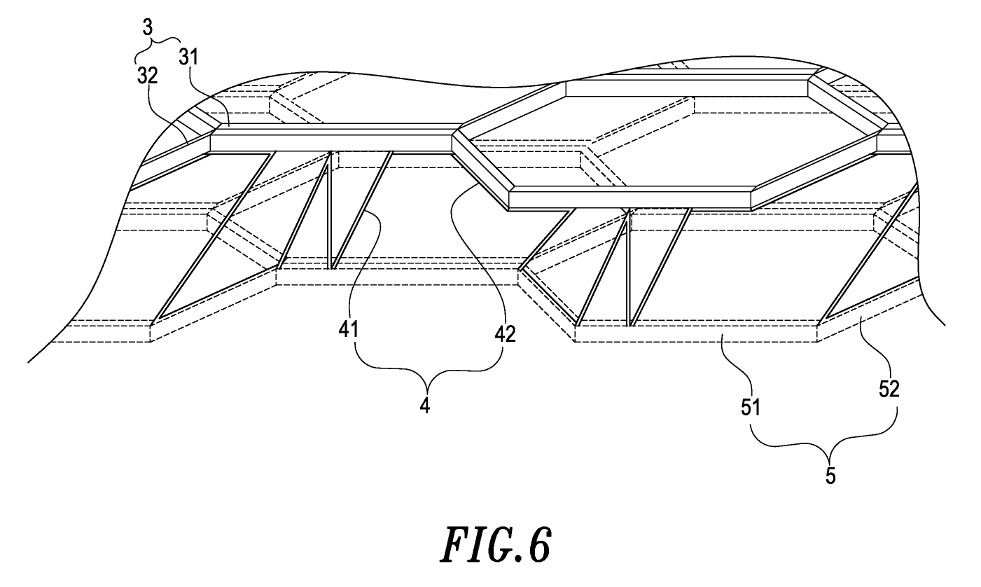

Please refer to FIG. 6 for a structural view of still another embodiment in the present invention. The difference between FIG. 6 and FIG. 5 is that the vertical yarn 41 of the middle support layer 4 only supports the front portion or the portion near the rear portion of the main segments 31, 51 of the surface mesh layer 3; and the front portion and the rear portion of the main segment 31 and the bottom mesh layer 5, and the front portion and the rear portion of the main segments 31, 51, and the extending segment 32, 52 lap with the horizontal yarn 42 of the middle support layer 4 to further reinforce the strength of the extending segments 32, 52. The rest of the structure in FIG. 6 is the same as that in FIG. 3 and will not be described for the sake of brevity.

Furthermore, since the extending segment 32 of the surface mesh layer 3 is not supported by the middle support layer 4 from down under, so when the surface mesh layer 3 is abraded, the extending segment 32 will not be directly abraded to break off easily; therefore the lifetime of the surface mesh layer is extended.

Hence, in order to prove the sustainability of the spacer fabric in the present invention, the inventor uses an abrasion tester to test the spacer fabric and the prior art spacer fabric, the prior art surface layer 13 breaks off from the extending segment 132 after only 150 cycles turned by the abrasion tester. On the other hand, the extending segment 32 of the surface mesh layer 3 breaks off after 300 cycles turned by the abrasion tester, proving that using the middle support layer 4 to reinforce the extending segment 32 of the surface mesh layer 3 can successfully increase the strength of the extending segment 32.

The present invention discloses a structure of spacer fabric surface layer and a reinforced knitting method of producing the structure, while compared to other prior art techniques, is advantageous in:

1. The present invention discloses a knitting method that, in the process of knitting the middle support layer, the yarn of the middle support layer is lapped with the extending segment of the surface mesh layer to reinforce the strength of the extending segment with the middle support layer.

2. The present invention is easy to produce and sustainable to prolong the lifetime of the product.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A knitting method for reinforcing a spacer fabric surface layer, comprising the following steps:
Step 1: disposing a yarn into a knitting machine;
Step 2: knitting the yarn to form a spacer fabric having a surface mesh layer, a middle support layer and a bottom fabric layer by using the knitting machine, wherein the surface mesh layer is consisted of a main segment having two loop strings lapping with each other and an extending segment having one single loop string, the middle support layer acts as a support between the main segment of the surface mesh layer and the bottom fabric layer and laps with the extending segment of the surface mesh layer to reinforce the extending segment, then moving the yarn up and down to knit the yarn between the main segment and the bottom fabric layer; and
Step 3: finishing the knitting of the three laminated layer fabric.

2. A reinforced structure of a spacer fabric surface layer, comprising:
a bottom fabric layer;
a surface mesh layer comprising a plurality of main segments having ends connected and a plurality of extending segments, each main segment comprising at least two lapping loop strings, and each extending segment only comprising one single loop string to let the surface mesh layer form in meshes;
wherein the reinforced structure is characterized in:
a middle support layer comprising a vertical yarn and a horizontal yarn, the vertical yarn having one end connected with the main segment of the surface mesh layer and the other end connected with the bottom fabric layer to act as a support to the surface mesh layer, and the horizontal yarn of the middle support layer lapping with the extending segment of the surface mesh layer to reinforce the strength of the extending segment.

3. The reinforced structure of the spacer fabric surface layer as claimed in claim 2, wherein the surface mesh layer comprises polyhedral meshes.

4. The reinforced structure of the spacer fabric surface layer as claimed in claim 2, wherein the vertical yarn of the middle support layer only supports the front portion or the portion near the rear portion of the main segment of the surface mesh layer; and the front portion and the rear portion of the main segment, and the extending segment lap with the horizontal yarn of the middle support layer.

5. The reinforced structure of the spacer fabric surface layer as claimed in claim 2, wherein the loop string is formed by stringing a plurality of loops.

6. A reinforced structure of a spacer fabric surface layer, comprising:
a bottom mesh layer comprising a plurality of main segments having ends connected and a plurality of extending segments, each main segment at least comprising at least two lapping loop strings, and each extending segment only comprising one single loop string to let the surface mesh layer form in meshes;
a surface mesh layer comprising a plurality of main segments having ends connected and a plurality of extending segments, each main segment at least comprising at least two lapping loop strings, and each extending segment only comprising one single loop string to let the surface mesh layer form in meshes;
wherein the reinforced structure is characterized in:
a middle support layer comprising a vertical yarn and a horizontal yarn, the vertical yarn having one end connected with the main segment of the surface mesh layer and the other end connected with the bottom fabric layer to act as a support to the surface mesh layer, and the horizontal yarn of the middle support layer lapping with the extending segment of the horizontal yarn to reinforce the strength of the extending segment.

7. The reinforced structure of the spacer fabric surface layer as claimed in claim 6, wherein the surface mesh layer comprises polyhedral meshes.

8. The reinforced structure of the spacer fabric surface layer as claimed in claim 6, wherein the vertical yarn of the middle support layer only supports the front portion or the portion near the rear portion of the main segment of the surface mesh layer; and the front portion and the rear portion of the main segment, and the extending segment lap with the horizontal yarn of the middle support layer.

9. The reinforced structure of the spacer fabric surface layer as claimed in claim 6, wherein the loop string is formed by stringing a plurality of loops.
